(19) United States
(12) Patent Application Publication
(10) Pub. No.: US 2022/0363869 A1
(43) Pub. Date: Nov. 17, 2022

(54) ADHESIVE COMPOSITION CONTAINING ORGANIC SILICON COMPOUND

(71) Applicant: SHIN-ETSU CHEMICAL CO., LTD., Tokyo (JP)

(72) Inventors: Shigeki YASUDA, Annaka-shi (JP); Munenao HIROKAMI, Annaka-shi (JP)

(73) Assignee: SHIN-ETSU CHEMICAL CO., LTD., Tokyo (JP)

(21) Appl. No.: 17/620,914

(22) PCT Filed: Jun. 11, 2020
(86) PCT No.: PCT/JP2020/023044

§ 371 Date: Dec. 20, 2021

(30) Foreign Application Priority Data
Jul. 1, 2019 (JP) 2019-123110

(51) Int. Cl. C08K 5/5445; C09J 11/06; C09J 175/04; C09J 163/00

(52) U.S. Cl. CPC C08K 5/5445; C09J 11/06; C09J 175/04; C09J 163/00

(57) ABSTRACT

An adhesive composition containing an organic silicon compound represented by formula (1).

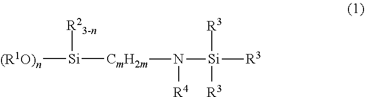

[In the formula, R¹ is an alkyl group or an aryl group, R² are an alkyl group or an aryl group. R³ are an alkyl group, an aryl group, an aralkyl group, an alkenyl group, or an alkoxy group, but at least one is an alkoxy group. R⁴ is an alkyl group, an aryl group, an aralkyl group, or an organic group represented by formula (2), n is an integer of 1-3, m is an integer of 1-12.

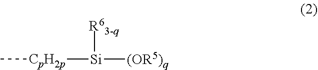

(In the formula, R⁵ is an alkyl group or an aryl group, R⁶ are an alkyl group or an aryl group, p is an integer of 0-12, q is an integer of 1-3. The broken line represents a bond.)]

### TECHNICAL FIELD

The present invention relates to an adhesive composition which includes an organosilicon compound having a hydrolyzable silyl group and an N—Si bond on the molecule.

### BACKGROUND ART

Silane coupling agents are compounds which have on a single molecule both a moiety that is reactive with inorganic matter (a silicon-bonded hydrolyzable group) and a moiety that is fully reactive with and soluble in organic matter. Because such agents act as an adhesive aid at interfaces between inorganic matter and organic matter, they are widely employed as composite resin modifiers.

Of these, aminoalkylsilane compounds are known to be useful in, for example, surface treatments, textile treatments, adhesives and paint additives. In particular, when added to a urethane prepolymer or an epoxy compound, the adhesiveness to substrates is known to improve.

For example, organosilicon compounds having a ketimine structure in which the amino group is protected by reaction with a carbonyl compound such as methyl isobutyl ketone are used in order to obtain one-part moisture-curable compositions. However, the shelf stability is poor and, when mixed with a polymeric material having isocyanate groups, epoxy groups or an acid anhydride, or when stored following mixture, problems such as an increase in viscosity or curing arise.

The prior art relating to the present invention includes the following.

### PRIOR ART DOCUMENTS

### Patent Documents

Patent Document 1: JP-A 2014-77094

### SUMMARY OF INVENTION

### Technical Problem

In view of the above circumstances, the object of the present invention is to provide an adhesive composition having an excellent adhesiveness and a high shelf stability.

### Solution to Problem

The inventors have conducted extensive investigations aimed at achieving these objects. As a result, they have discovered that by including a specific organosilicon compound having a hydrolyzable silyl group and a N—Si bond in an adhesive composition, an adhesive composition having excellent adhesiveness and a high shelf stability can be obtained. This discovery ultimately led to the present invention.

Accordingly, the present invention provides:

[1]

An adhesive composition which includes an organosilicon compound of formula (1) below

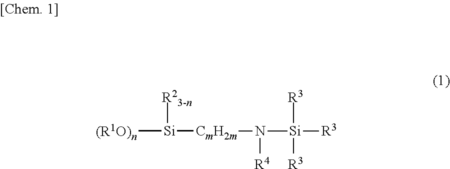

(wherein each R¹ is independently an alkyl group of 1 to 10 carbon atoms or an aryl group of 6 to 10 carbon atoms; each R² is independently an alkyl group of 1 to 10 carbon atoms or an aryl group of 6 to 10 carbon atoms; each R³ is independently a substituted or unsubstituted alkyl group of 1 to 20 carbon atoms, a substituted or unsubstituted aryl group of 6 to 10 carbon atoms, a substituted or unsubstituted aralkyl group of 7 to 10 carbon atoms, a substituted or unsubstituted alkenyl group of 2 to 10 carbon atoms or a substituted or unsubstituted alkoxy group of 1 to 20 carbon atoms, with the proviso that at least one R³ is a substituted or unsubstituted alkoxy group of 1 to 20 carbon atoms; R⁴ is an alkyl group of 1 to 10 carbon atoms, an aryl group of 6 to 10 carbon atoms, an aralkyl group of 7 to 10 carbon atoms or an organic group of formula (2) below

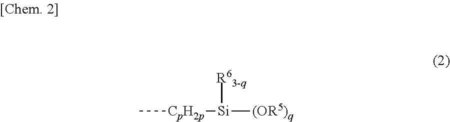

(each R⁵ being independently an alkyl group of 1 to 10 carbon atoms or an aryl group of 6 to 10 carbon atoms; each R⁶ being independently an alkyl group of 1 to 10 carbon atoms or an aryl group of 6 to 10 carbon atoms; p being an integer from 0 to 12; q being an integer from 1 to 3; and the dashed line representing a bond); n is an integer from 1 to 3; and m is an integer from 1 to 12);
[2]

The adhesive composition of [1], wherein the organosilicon compound includes at least one organosilicon compound of formulas (7) to (12) below

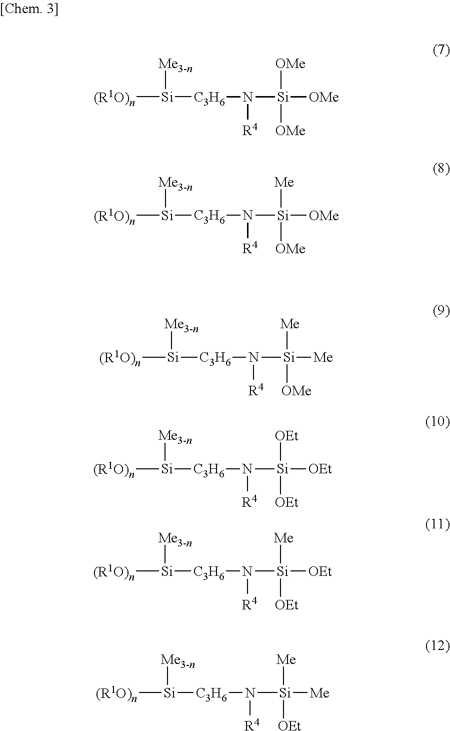

(wherein R¹, R⁴ and n are as defined above, Me represents a methyl group and Et represents an ethyl group);
[3]

The adhesive composition of [1] or [2] which includes from 0.01 to 10 parts by weight of the organosilicon compound of formula (1) per 100 parts by weight of a urethane prepolymer; and

[4]

The adhesive composition of [1] or [2] which includes from 0.01 to 10 parts by weight of the organosilicon compound of formula (1) per 100 parts by weight of an epoxy compound.

### Advantageous Effects of Invention

The adhesive composition of the invention has an excellent shelf stability. Moreover, modified resins that are surface treated with the inventive composition have an excellent adhesiveness to glass and various other inorganic materials.

### DESCRIPTION OF EMBODIMENTS

The invention is described in detail below. In this invention, the term “silane coupling agent” is encompassed by the term “organosilicon compound.”

The adhesive composition of the invention, by including an organosilicon compound of formula (1) below which has a hydrolyzable silyl group and an N—Si bond on a single molecule, exhibits a high shelf stability.

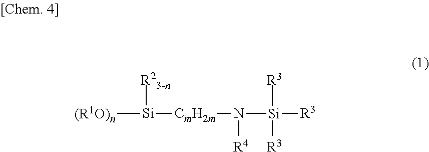

In formula (1), each R¹ is independently an alkyl group of 1 to 10 carbon atoms or an aryl group of 6 to 10 carbon atoms; each R² is independently an alkyl group of 1 to 10 carbon atoms or an aryl group of 6 to 10 carbon atoms; each R³ is independently a substituted or unsubstituted alkyl group of 1 to 20 carbon atoms, a substituted or unsubstituted aryl group of 6 to 10 carbon atoms, a substituted or unsubstituted aralkyl group of 7 to 10 carbon atoms, a substituted or unsubstituted alkenyl group of 2 to 10 carbon atoms or a substituted or unsubstituted alkoxy group of 1 to 20 carbon atoms, with the proviso that at least one R³ is a substituted or unsubstituted alkoxy group of 1 to 20 carbon atoms; R⁴ is an alkyl group of 1 to 10 carbon atoms, an aryl group of 6 to 10 carbon atoms, an aralkyl group of 7 to 10 carbon atoms or an organic group of formula (2) below; n is an integer from 1 to 3; and m is an integer from 1 to 12.

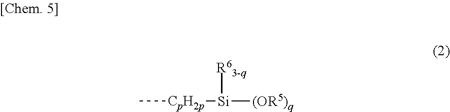

In formula (2), each R⁵ is independently an alkyl group of 1 to 10 carbon atoms or an aryl group of 6 to 10 carbon atoms; each R⁶ is independently an alkyl group of 1 to 10 carbon atoms or an aryl group of 6 to 10 carbon atoms; p is an integer from 0 to 12; q is an integer from 1 to 3; and the dashed line represents a bond.

The alkyl group having from 1 to 10 carbon atoms of R¹ and R² is preferably an alkyl group of 1 to 8 carbon atoms, and may be linear, cyclic or branched. Specific examples include methyl, ethyl, n-propyl, i-propyl, n-butyl, isobutyl, s-butyl, t-butyl, n-pentyl, neopentyl, n-hexyl, n-heptyl, n-octyl, n-nonyl, n-decyl, cyclopropyl, cyclobutyl cyclopentyl, cyclohexyl, cycloheptyl and cyclooctyl groups.

Specific examples of the aryl groups of 6 to 10 carbon atoms include phenyl, α-naphthyl and β-naphthyl groups.

Of these, R¹ and R² are preferably linear alkyl groups; methyl and ethyl groups are more preferred.

The alkyl group of R³ is preferably one having from 1 to 10 carbon atoms, and may be linear, cyclic or branched. Specific examples include methyl, ethyl, tert-butyl, octyl, decyl and dodecyl groups. The aryl group is preferably one having from 6 to 8 carbon atoms, examples of which include phenyl, xylyl and tolyl groups. The aralkyl group is preferably one having from 7 to 9 carbon atoms, an example of which is the benzyl group. The alkenyl group is preferably one having from 2 to 8 carbon atoms, examples of which include vinyl, propenyl and pentenyl groups. The alkoxy group is preferably one having from 1 to 10 carbon atoms, examples of which include methoxy, ethoxy, propoxy, butoxy, octoxy and dodecoxy groups. Additional examples include the above groups in which some or all of the hydrogen atoms bonded to carbon atoms are substituted with halogen atoms such as chlorine and bromine atoms, cyano groups, epoxy ring-containing groups, alkoxy groups or the like, as exemplified by halogenated alkyl groups such as chloromethyl, 3-chloropropyl and 3,3,3-trifluoropropyl, and also the 2-cyanoethyl, 3-glycidoxypropyl, chlorophenyl, chlorobenzyl, chloropentenyl and methoxyethoxy groups. Of these, methyl, ethyl, methoxy and ethoxy groups are preferred. A methoxy or ethoxy group that is a substituted or unsubstituted alkoxy group in which at least one, preferably two or more, and more preferably three hydrogen atoms are substituted or that is unsubstituted is desirable.

The alkyl group of R⁴ is preferably one having from 1 to 8 carbon atoms, specific examples of which include methyl, ethyl, n-propyl, isopropyl, n-butyl, sec-butyl, tert-butyl, octyl, decyl and dodecyl groups. The aryl group is preferably one having from 6 to 8 carbon atoms, specific examples of which include phenyl, xylyl and tolyl groups. The aralkyl group is preferably one having from 7 to 9 carbon atoms, an example of which is the benzyl group. Of these, methyl, ethyl, n-propyl, n-butyl and tert-butyl groups are preferred.

In addition, from the standpoint of adhesiveness to a substrate, a hydrolyzable silyl group of formula (2) may be used as R⁴. In formula (2), the alkyl groups of R⁵ and R⁶ are preferably ones having from 1 to 8 carbon atoms, and the aryl groups are preferably ones having from 6 to 8 carbon atoms. Specific examples of these include the same as those mentioned for R⁴, with methyl and ethyl groups being preferred. The subscript p is preferably an integer from 0 to 10, and more preferably an integer from 1 to 5. The subscript q is an integer from 1 to 3. Groups of formulas (3) to (6) below are preferred as specific examples of the group of formula (2).

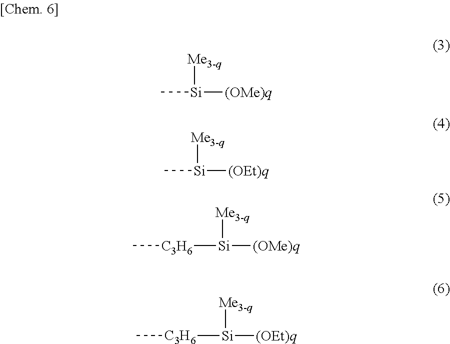

Here, q is an integer from 1 to 3, Me stands for a methyl group, Et stands for an ethyl group, and the dashed line represents a bond.

The subscript n is an integer from 1 to 3, preferably 2 or 3, and more preferably 3. Also, the subscript m is an integer from 1 to 12, preferably 2 or 3, and more preferably 3.

More preferred examples of the compound of formula (1) include the compounds of formulas (7) to (12) below. One of these may be used alone, or two or more may be used in combination, as the organosilicon compound.

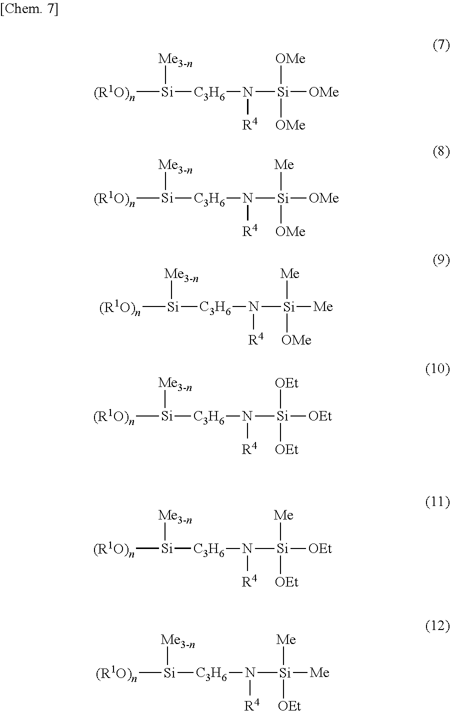

Here, R¹, R⁴ and n are the same as above, Me stands for a methyl group, and Et stands for an ethyl group.

Even more specific examples include, but are not limited to, the following.

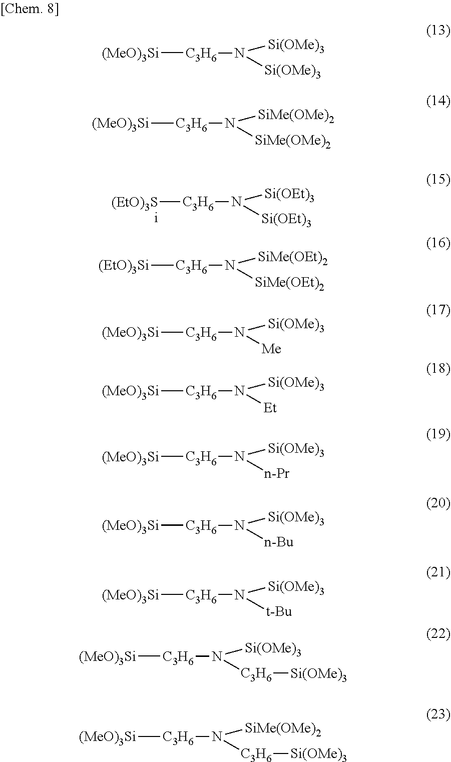

Here, Me stands for a methyl group, Et stands for an ethyl group, Bu stands for a butyl group and Pr stands for a propyl group.

The organosilicon compound can be prepared by, for example, heating an organosilicon compound having an alkoxysilyl group and an amino group together with a compound having an alkoxysilyl group at the α-position on a carbonyl group to about 110 to 130° C. in the presence of a phase transfer catalyst such as tetrabutylammonium bromide, although the method of preparation is not limited to this. The organosilicon compound having an alkoxysilyl group and the compound having an alkoxysilyl group at the α-position on a carbonyl group are each selected according to the target compound.

Specifically, the compound of formula (13) can be prepared by using 3-trimethoxysilylpropylamine as the organosilicon compound having an alkoxysilyl group and using ethyl-2-trimethoxysilylpropanoate as the compound having an alkoxysilyl group at the α-position on a carbonyl group.

This reaction proceeds even in the absence of a solvent, although a solvent may be used. Specific examples of solvents that can be used include hydrocarbon solvents such as pentane, hexane, cyclohexane, heptane, isooctane, benzene, toluene and xylene.

The base resin of the adhesive composition containing the organosilicon compound is exemplified by urethane resins, epoxy resins and other epoxy compounds, acrylic resins and polyester resins, although urethane resins and epoxy resins are preferred. When using a urethane resin, it is preferable to utilize a urethane prepolymer and cure this by crosslinking it with a crosslinking agent.

Amine compounds commonly give rise to addition reactions with isocyanate compounds and epoxy compounds, and so when an amine compound is mixed with a urethane prepolymer or an epoxy resin, the shelf stability sometimes worsens.

In this respect, because the organosilicon compound included in the adhesive composition of the invention lacks an amino group having active hydrogens and does not give rise to an addition reaction, even when mixed with an isocyanate compound or an epoxy compound, the reaction does not proceed, resulting in a good shelf stability.

The inventive composition, by using, for example, a urethane prepolymer as the base resin and using together with this the above organosilicon compound (1), is able to stably exhibit an excellent adhesiveness to adherends without the use of a primer composition. In particular, the inventive compositions containing an organosilicon compound and a urethane prepolymer exhibit an excellent adhesiveness to adherends made of materials such as glass or olefinic resins (e.g., polypropylene resin).

That is, the hydrolyzable silyl groups (Si—OR groups) on the above organosilicon compound are hydrolyzed by moisture in the air, becoming silanol groups (Si—OH group). These react with OH groups in glass or the like, forming Si—O—Si bonds and thus resulting in a high adhesiveness. In addition, the N—Si bond is deprotected by moisture in the air, forming a primary amino group (—NH₂ group) or a group in which R⁴ is represented by formula (2); when p is 1 or more, a secondary amino group (—NHR⁴) forms. The amino group reacts with the NCO group on the urethane prepolymer, resulting in the formation of a urea bond and exhibiting a high adhesiveness.

In this case, the content of the organosilicon compound is preferably from 0.01 to 10 parts by weight per 100 parts by weight of the urethane prepolymer serving as the base resin. To achieve both improved adhesiveness and a low cost, the content is more preferably from 0.5 to 8 parts by weight.

The urethane prepolymer can be obtained by reacting a polyol having two or more hydroxyl groups (OH) with a polyisocyanate compound having two or more isocyanate groups (NCO) in such a way as to have a surplus of isocyanate groups; i.e., such that the molar ratio NCO/OH becomes larger than 1.

The reaction conditions may consist of, for example, mixing the reactants in proportions such that the NCO/OH equivalent ratio is from 1.0 to 15.0, preferably from 1.0 to 8.0, and reacting for several hours at between 70° C. and 100° C. in a stream of nitrogen or dry air.

A diisocyanate-terminated urethane prepolymer can be obtained by the above reaction. The NCO content of the resulting NCO-containing prepolymer is preferably in the range of 5 to 25 wt %.

The polyisocyanate compound is not particularly limited, provided that it has two or more isocyanate groups on the molecule. Examples include aromatic polyisocyanates such as 2,4-tolylene diisocyanate (2,4-TDI), 2,6-tolylene diisocyanate (2,6-TDI), 4,4′-diphenylmethane diisocyanate (4,4′-MDI), 2,2′-diphenylmethane diisocyanate (2,2′-MDI), 2,4′-diphenylmethane diisocyanate (2,4′-MDI), 1,4-phenylene diisocyanate, polymethylene polyphenylene polyisocyanate, tolidine diisocyanate (TODI), 1,5-naphthalene diisocyanate (NDI), xylylene diisocyanate (XDI), tetramethylxylylene diisocyanate (TMXDI) and triphenylmethane triisocyanate; aliphatic polyisocyanates such as hexamethylene diisocyanate (HDI), trimethylhexamethylene diisocyanate (TMHDI), lysine diisocyanate and norbornane diisocyanate (NBDI); alicyclic polyisocyanates such as trans-1,4-cyclohexane diisocyanate, isophorone diisocyanate (IPDI), bis(isocyanatomethyl)cyclohexane (H6XDI) and dicyclohexylmethane diisocyanate (H12MDI); polyisocyanate compounds such as polymethylene polyphenylene polyisocyanate; carbodiimide-modified polyisocyanates of these isocyanate compounds; isocyanurate-modified polyisocyanates of these isocyanate compounds; and urethane prepolymers obtained by reacting these isocyanate compounds with the subsequently mentioned polyol compounds. These polyisocyanate compounds may be of one type used alone, or two or more may be used in combination.

The polyol compound too is not particularly limited and may be suitably selected from among known polyols such as polyether polyols, polyester polyols, acrylic polyols and polycarbonate polyols. These polyols may be of one type used alone, or two or more may be used in combination.

Specific examples of polyol compounds include polypropylene ether diol, polyethylene ether diol, polypropylene ether triol, polytetramethylene glycol, polyethylene glycol (PEG), polypropylene glycol (PPG), polyoxyethylene glycol, polyoxypropylene glycol, polyoxypropylene triol, polyoxybutylene glycol, polytetramethylene ether glycol (PTMG), polymer polyols, poly(ethylene adipate), poly(diethylene adipate), poly(propylene adipate), poly(tetramethylene adipate), poly(hexamethylene adipate), poly(neopentylene adipate), poly-ε-caprolactone, poly(hexamethylene carbonate) and naturally occurring polyol compounds such as castor oil.

Here, the polyol compound has a polystyrene-equivalent number-average molecular weight according to gel permeation chromatography (GPC) that is preferably in the range of 1,000 to 20,000, and especially 2,000 to 10,000.

Even with the addition of the above organosilicon compound to an epoxy resin, it is possible to obtain an adhesive composition that stably possesses an excellent adhesiveness to adherends without the use of a primer composition. In particular, compositions containing the above organosilicon compound and an epoxy resin exhibit excellent adhesiveness to adherends made of glass and adherends made of metals, such as stainless steel plate.

That is, hydrolyzable silyl groups (Si—OR groups) on the organosilicon compound are hydrolyzed by moisture in the air, becoming silanol groups (Si—OH groups), which react with OH groups in glass or the like, forming Si—O—Si bonds and thus exhibiting high adhesiveness. In addition, the N—Si bond is deprotected by moisture in the air, becoming a primary amino group (—NH₂ group) or a group in which R⁴ is represented by formula (2); when p is 1 or more, a secondary amino group (—NHR⁴) forms. The amino group reacts with an epoxy group on the epoxy resin, exhibiting a high adhesiveness.

In this case, the organosilicon compound content is preferably from 0.01 to 10 parts by weight per 100 parts by weight of the epoxy resin serving as the base resin. To achieve both an improved adhesiveness and a low cost, the content is more preferably from 0.5 to 8 parts by weight.

The epoxy resin is not particularly limited so long as it is generally a compound having two or more epoxy groups per molecule, and is exemplified by epoxy resins obtained by the condensation of epichlorohydrin with a polyphenol such as bisphenol or a polyhydric alcohol.

Specific examples include the following glycidyl ether-type epoxy resins: bisphenol A epoxy resins, brominated bisphenol A epoxy resins, hydrogenated bisphenol A epoxy resins, bisphenol F epoxy resins, bisphenol S epoxy resins, bisphenol AF epoxy resins, biphenyl epoxy resins, naphthalene epoxy resins, fluorene epoxy resins, novolak epoxy resins, phenolic novolak epoxy resins, o-cresol novolak epoxy resins, tris(hydroxyphenyl)methane epoxy resins and tetraphenylolethane epoxy resins.

Additional examples include, but are not limited to, glycidyl ester-type epoxy resins obtained by the condensation of epichlorohydrin with a carboxylic acid such as a phthalic acid derivative or a fatty acid; glycidyl amine-type epoxy resins obtained by reacting epichlorohydrin with an amine, a cyanuric acid compound or a hydantoin compound; and epoxy resins modified by various methods.

The above epoxy resins may be of one type used alone, or two or more may be used in combination.

Of these, taking the aspect of cost into account, bisphenol A epoxy resins and bisphenol F type epoxy resins are preferred.

Bisphenol A epoxy resins and bisphenol F epoxy resins can be acquired as commercial products. Examples of commercial bisphenol A epoxy resins include jER828 from Mitsubishi Chemical Corporation and DER331 from the Dow Chemical Company. Examples of commercial bisphenol F epoxy resins include jER807 and jER1750 from Mitsubishi Chemical Corporation.

In addition to the above ingredients, the inventive composition may also optionally include various additives such as curing catalysts, adhesion promoters, property modifiers, fillers, plasticizers, thixotropic agents, dehydrating agents (shelf stability enhancers), tackifiers, anti-sag agents, ultraviolet absorbers, antioxidants, flame retardants, colorants and radical polymerization initiators, and various solvents such as toluene and alcohol.

In cases where a catalyst is used in a urethane composition, the catalyst is not particularly limited so long as it is one that is capable of reacting with the base resin.

Specific examples include divalent organotin compounds such as tin octanoate, tin octylate, tin butanoate, tin naphthenate, tin caprylate, tin oleate and tin laurate; tetravalent organotin compounds such as dibutyltin dioctoate, dibutyltin dilaurate, dibutyltin diacetate, dibutyltin dimaleate, dibutyltin distearate, dibutyltin dioleate, dibutyltin benzoate, dioctyltin dilaurate, dioctyltin diversatate, diphenyltin diacetate, dibutyltin dimethoxide, dibutyltin oxide, dibutyltin bis(triethoxysilicate) and the reaction products of dibutyltin oxide and phthalic acid esters; metal catalysts such as bismuth octylate; the following amine compounds and carboxylic acid salts thereof primary amines such as butylamine, hexylamine, octylamine, dodecylamine, oleylamine, cyclohexylamine and benzylamine; secondary amines such as dibutylamine; polyamines such as diethylenetriamine, triethylenetetramine, guanidine, diphenylguanidine and xylylenediamine; cyclic amines such as triethylenediamine and derivatives thereof, 2-methyltriethylenediamine, morpholine, N-methylmorpholine, 2-ethyl-4-methylimidazole and 1,8-diazabicyclo[5.4.0]-7-undecene; aminoalcohol compounds such as monoethanolamine, diethanolamine and triethanolamine; and aminophenol compounds such as 2,4,6-tris(dimethylaminomethyl)phenol; quaternary ammonium salts such as benzyltriethylammonium acetate; low-molecular-weight amide resins obtained from surplus polyamine and a polybasic acid; and the product of surplus polyamine reacted with an epoxy compound. These catalysts may be of one type used alone, or two or more may be used together.

When these catalysts are used, the content thereof per 100 parts by weight of the inventive composition is preferably from 0.01 to 5 parts by weight, and more preferably from 0.1 to 2 parts by weight.

Even among these, from the standpoint of having a large catalytic activity in a very small amount, tin-based catalysts and amine-type catalysts are preferred.

In cases where a catalyst is used in an epoxy composition, the catalyst is not particularly limited so long as it is one that is capable of reacting with the base resin.

Specific examples include aliphatic amines such as diethylenetriamine, triethylenetetramine, tetraethylenepentamine, diethylaminopropylamine, hexamethylenediamine, methylpentamethylenediamine, trimethylhexamethylenediamine, guanidine and oleylamine; alicyclic amines such as menthenediamine, isophoronediamine, norbomanediamine, piperidine, N,N′-dimethylpiperazine, N-aminoethylpiperazine, 1,2-diaminocyclohexane, bis(4-amino-3-methylcyclohexyl)methane, bis(4-aminocyclohexyl)methane, polycyclohexylpolyamine and 1,8-diazabicyclo[5,4,0]undecene-7 (DBU); amines having an ether bond, such as 3,9-bis(3-aminopropyl)-2,4,8,10-tetraoxaspiro[5,5]undecane (ATU), morpholine, N-methylmorpholine, polyoxypropylenediamine, polyoxypropylenetriamine and polyoxyethylenediamine; hydroxyl group-containing amines such as diethanolamine and triethanolamine; aminosilanes such as γ-aminopropyltrimethoxysilane, γ-aminopropyltriethoxysilane, γ-aminopropyltriisopropoxysilane, γ-aminopropylmethyldimethoxysilane, γ-aminopropylmethyldiethoxysilane, γ-(2-aminoethyl)aminopropyltrimethoxysilane, γ-(2-aminoethyl)aminopropylmethyldimethoxysilane, γ-(2-aminoethyl)aminopropyltriethoxysilane, γ-(2-aminoethyl)aminopropylmethyldiethoxysilane, γ-(2-aminoethyl)aminopropyltriisopropoxysilane, γ-(2-(2-aminoethyl)aminoethyl)aminopropyltrimethoxysilane, γ-(6-aminohexyl)aminopropyltrimethoxysilane, 3-(N-ethylamino)-2-methylpropyltrimethoxysilane, 2-aminoethylaminomethyltrimethoxysilane, N-cyclohexylaminomethyltriethoxysilane, N-cyclohexylaminomethyldiethoxymethylsilane, γ-ureidopropyltrimethoxysilane, γ-ureidopropyltriethoxysilane, N-phenyl-γ-aminopropyltrimethoxysilane, N-phenylaminomethyltrimethoxysilane, N-benzyl-γ-aminopropyltrimethoxysilane, N-vinylbenzyl-γ-aminopropyltriethoxysilane, N-(3-triethoxysilylpropyl)-4,5-dihydroimidazole, N-cyclohexylaminomethyltriethoxysilane, N-cyclohexylaminomethyldiethoxymethylsilane, N-phenylaminomethyltrimethoxysilane, (2-aminoethyl)aminomethyltrimethoxysilane and N,N′-bis[3-(trimethoxysilyl)propyl]ethylenediamine; ketimine-type silanes such as N-(1,3-dimethylbutylidene)-3-(triethoxysilyl)-1-propaneamine; acid anhydrides such as tetrahydrophthalic anhydride, methyltetrahydrophthalic anhydride, methyl nadic anhydride, hexahydrophthalic anhydride and dodecyl succinic anhydride; polyamidoamines such as polyamides obtained by reacting a polyamine such as diethylenetriamine or triethylenetetramine with a dimer acid, and polyamides obtained using polycarboxylic acids other than a dimer acid; imidazoles such as 2-ethyl-4-methylimidazole; dicyandiamide; and the following modified amines: epoxy-modified amines obtained by reacting an epoxy compound with the above amines, Mannich-modified amines obtained by reacting formalin and phenols with the above amines, Michael addition-modified amines, and ketimines. These curing agents may be used singly, or two or more may be used together.

When these catalysts are used, the content thereof per 100 parts by weight of the inventive composition is preferably from 1 to 100 parts by weight, and more preferably from 5 to 50 parts by weight.

When a filler is used, the type thereof is not particularly limited. Examples include inorganic fillers such as calcium carbonate, aluminum hydroxide, carbon black, white carbon, silica, glass, kaolin, talc (magnesium silicate), fumed silica, precipitated silica, silicic anhydride, hydrated silica, clay, fired clay, bentonite, glass fibers, asbestos, glass filaments, ground quartz, diatomaceous earth, aluminum silicate, zinc oxide, magnesium oxide, titanium oxide and surface treated products of these; organic fillers such as carbonates, organic bentonite, high-styrene resins, coumarone-indene resins, phenolic resins, formaldehyde resins, modified melamine resins, cyclized rubber, lignin, ebonite powder, shellac, cork powder, bone meal, wood flour, cellulose powder, coconut shell flour and wood pulp; inorganic pigments such as lamp black, titanium white, red iron oxide, titanium yellow, zinc white, red lead, cobalt blue, iron black and aluminum powder; and organic pigments such as Neozapon Black RE, Neo Black RE, Orasol Black CN and Orasol Black Ba (all from Ciba-Geigy), and Spilon Blue-2BH (from Hodogaya Chemical Co., Ltd.).

Of these, to impart the desired properties, it is preferable to use at least one selected from carbon black and calcium carbonate.

The carbon black and calcium carbonate are not particularly limited; use may be made of ones that are normally available commercially. Examples of carbon blacks include those of grades N110, N220, N330, N550, N770, and mixtures thereof, in the American Society for Testing and Materials (ASTM) standards. Examples of calcium carbonates include ground calcium carbonate and precipitated calcium carbonate.

These fillers may be of one type used alone, or two or more may be used together. When a filler is used, the content thereof is preferably from 0.1 to 100 parts by weight, and more preferably from 1 to 70 parts by weight, per 100 parts by weight of the inventive composition.

Because the above-described composition of the invention has an excellent adhesiveness, it can be advantageously used as an adhesive in the automotive, train and other rolling stock, ship, aircraft, construction and civil engineering, electronics and space industry fields, and in other industrial products as well.

### EXAMPLES

Synthesis Examples, Examples and Comparative Examples are given below to more concretely illustrate the invention, although the invention is not limited by these Examples. In the Examples below, “Me” stands for a methyl group, “Et” stands for an ethyl group and “Bu” stands for a butyl group.

### [1] Synthesis of Organosilicon Compounds

### Synthesis Example 1

A 2-liter separable flask equipped with a stirrer, a reflex condenser, a dropping funnel and a thermometer was charged with 1,487.2 g (6.69 mol) of ethyl-2-trimethoxysilylpropanoate and 75.5 g of tetrabutylammonium bromide, and 400.0 g (2.23 mol) of 3-trimethoxysilylpropylamine was added dropwise over a period of one hour at an internal temperature of 120 to 125° C. The system was then stirred for 7 hours at 125° C. and analyzed by gas chromatography, whereupon the 3-trimethoxysilylpropylamine peak was found to have disappeared. The resulting solution was filtered under applied pressure, removing the tetrabutylammonium bromide. The resulting solution was purified by distillation at 5 mmHg and 170° C., giving 160 g of a clear colorless liquid. This was confirmed by ¹H-NMR to be an organosilicon compound of formula (13) above.

### Synthesis Example 2

A 2-liter separable flask equipped with a stirrer, a reflex condenser, a dropping funnel and a thermometer was charged with 1,380.1 g (6.69 mol) of ethyl-2-methyldimethoxysilylpropanoate and 71.2 g of tetrabutylammonium bromide, and 400.0 g (1.70 mol) of 3-trimethoxysilylpropylamine was added dropwise over a period of one hour at an internal temperature of 120 to 125° C. The system was then stirred for 7 hours at 125° C. and analyzed by gas chromatography, whereupon the 3-trimethoxysilylpropylamine peak was found to have disappeared. The resulting solution was filtered under applied pressure, removing the tetrabutylammonium bromide. The resulting solution was purified by distillation at 5 mmHg and 165° C., giving 150 g of a clear colorless liquid. This was confirmed by ¹H-NMR to be an organosilicon compound of formula (14) above.

### Synthesis Example 3

A 2-liter separable flask equipped with a stirrer, a reflex condenser, a dropping funnel and a thermometer was charged with 1,348.4 g (5.10 mol) of ethyl-2-triethoxysilylpropanoate and 69.0 g of tetrabutylammonium bromide, and 376.4 g (1.70 mol) of 3-triethoxysilylpropylamine was added dropwise over a period of one hour at an internal temperature of 120 to 125° C. The system was then stirred for 7 hours at 125° C. and analyzed by gas chromatography, whereupon the 3-triethoxysilylpropylamine peak was found to have disappeared. The resulting solution was filtered under applied pressure, removing the tetrabutylammonium bromide. The resulting solution was purified by distillation at 5 mmHg and 177° C., giving 150 g of a clear colorless liquid. This was confirmed by ¹H-NMR to be an organosilicon compound of formula (15) above.

### Synthesis Example 4

A 2-liter separable flask equipped with a stirrer, a reflex condenser, a dropping funnel and a thermometer was charged with 1,111.5 g (5.00 mol) of ethyl-2-trimethoxysilylpropanoate and 68.0 g of tetrabutylammonium bromide, and 588.5 g (2.50 mol) of N-[3-(trimethoxysilyl)propyl]-1-butanamine was added dropwise over a period of one hour at an internal temperature of 120 to 125° C. The system was then stirred for 7 hours at 125° C. and analyzed by gas chromatography, whereupon the 3-trimethoxysilylpropylamine peak was found to have disappeared. The resulting solution was filtered under applied pressure, removing the tetrabutylammonium bromide. The resulting solution was purified by distillation at 5 mmHg and 174° C., giving 140 g of a clear colorless liquid. This was confirmed by ¹H-NMR to be an organosilicon compound of formula (20) above.

### Synthesis Example 5

A 2-liter separable flask equipped with a stirrer, a reflex condenser, a dropping funnel and a thermometer was charged with 1,111.5 g (5.00 mol) of ethyl-2-trimethoxysilylpropanoate and 78.6 g of tetrabutylammonium bromide, and 853.0 g (2.50 mol) of bis[3-(trimethoxysilyl)propyl]amine was added dropwise over a period of one hour at an internal temperature of 120 to 125° C. The system was then stirred for 7 hours at 125° C. and analyzed by gas chromatography, whereupon the 3-trimethoxysilylpropylamine peak was found to have disappeared. The resulting solution was filtered under applied pressure, removing the tetrabutylammonium bromide. The resulting solution was purified by distillation at 5 mmHg and 179° C., giving 140 g of a clear colorless liquid. This was confirmed by ¹H-NMR to be an organosilicon compound of formula (22) above.

### [1] Evaluation of Shelf Stability of Compositions

### Examples 1-1 to 1-5 and 2-1 to 2-5, and Comparative Examples 1-1 to 1-4 and 2-1 to 2-4

The compositions were prepared by mixing the ingredients together in the usual manner in the proportions shown in Tables 1 and 2 below.

### [Shelf Stability]

The initial viscosities at 25° C. of the resulting compositions were measured based on JIS Z 8803. The change in viscosity following storage of the compositions for a given period of time at a constant temperature of 25° C. was similarly measured. The results are shown in Tables 1 and 2.

TABLE 1

| | Example | | | | | Comparative Example | | | |
|---|---|---|---|---|---|---|---|---|---|
| Ingredients (pbw) | 1-1 | 1-2 | 1-3 | 1-4 | 1-5 | 1-1 | 1-2 | 1-3 | 1-4 |
| Isocyanate compound | 100 | 100 | 100 | 100 | 100 | 100 | 100 | 100 | 100 |
| Organosilicon compound (13) | 5 | — | — | — | — | — | — | — | — |
| Organosilicon compound (14) | — | 5 | — | — | — | — | — | — | — |
| Organosilicon compound (15) | — | — | 5 | — | — | — | — | — | — |
| Organosilicon compound (20) | — | — | — | 5 | — | — | — | — | — |
| Organosilicon compound (22) | — | — | — | — | 5 | — | — | — | — |
| Organosilicon compound (24) | — | — | — | — | — | 5 | — | — | — |
| Organosilicon compound (25) | — | — | — | — | — | — | 5 | — | — |
| Organosilicon compound (26) | — | — | — | — | — | — | — | 5 | — |
| Organosilicon compound (27) | — | — | — | — | — | — | — | — | 5 |

Viscosity (Pa · s)

| | | | | | | | | | |
|---|---|---|---|---|---|---|---|---|---|
| Initial | 140 | 150 | 140 | 140 | 270 | solidified | solidified | 300 | 400 |
| After 1 day | 140 | 150 | 140 | 150 | 270 | solidified | solidified | 400 | 510 |
| After 7 days | 150 | 150 | 150 | 160 | 280 | solidified | solidified | 900 | 1,100 |
| After 14 days | 160 | 160 | 170 | 180 | 340 | solidified | solidified | 2,100 | 3,100 |

TABLE 2

| | Example | | | | | Comparative Example | | | |
|---|---|---|---|---|---|---|---|---|---|
| Ingredients (pbw) | 2-1 | 2-2 | 2-3 | 2-4 | 2-5 | 2-1 | 2-2 | 2-3 | 2-4 |
| Epoxy resin | 100 | 100 | 100 | 100 | 100 | 100 | 100 | 100 | 100 |
| Organosilicon compound (13) | 5 | — | — | — | — | — | — | — | — |
| Organosilicon compound (14) | — | 5 | — | — | — | — | — | — | — |
| Organosilicon compound (15) | — | — | 5 | — | — | — | — | — | — |
| Organosilicon compound (20) | — | — | — | 5 | — | — | — | — | — |
| Organosilicon compound (22) | — | — | — | — | 5 | — | — | — | — |
| Organosilicon compound (24) | — | — | — | — | — | 5 | — | — | — |
| Organosilicon compound (25) | — | — | — | — | — | — | 5 | — | — |
| Organosilicon compound (26) | — | — | — | — | — | — | — | 5 | — |
| Organosilicon compound (27) | — | — | — | — | — | — | — | — | 5 |

Viscosity (Pa · s)

| | | | | | | | | | |
|---|---|---|---|---|---|---|---|---|---|
| Initial | 5,300 | 5,400 | 5,300 | 6,000 | 7,500 | 7,400 | 7,500 | 7,500 | 7,700 |
| After 1 day | 5,500 | 5,500 | 5,400 | 6,100 | 8,000 | 40,000 | 41,000 | 10,000 | 9,700 |
| After 7 days | 5,600 | 5,700 | 5,500 | 6,200 | 8,000 | 44,000 | 44,000 | 15,000 | 11,000 |
| After 14 days | 5,600 | 5,800 | 5,600 | 6,200 | 8,100 | 44,000 | 45,000 | 16,000 | 12,000 |

Isocyanate compound: Cosmonate M-200 (Mitsui Fine Chemicals, Inc.)
Epoxy resin: jER828 (Mitsubishi Chemical Corporation)
Organosilicon compound (13): The organosilicon compound of formula (13) below

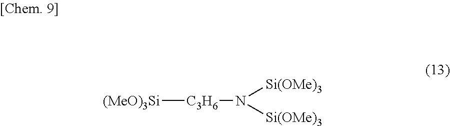

Organosilicon compound (14): The organosilicon compound of formula (14) below

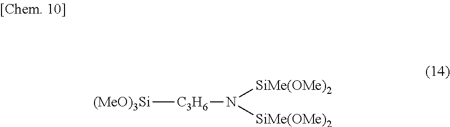

Organosilicon compound (15): The organosilicon compound of formula (15) below

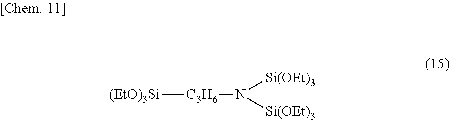

Organosilicon compound (20): The organosilicon compound of formula (20) below

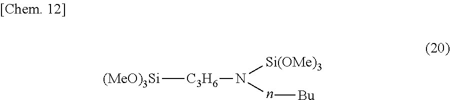

Organosilicon compound (22): The organosilicon compound of formula (22) below

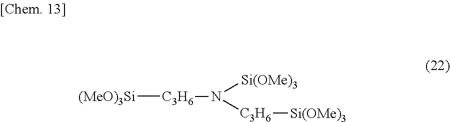

Organosilicon compound (24): 3-Aminopropyltrimethoxsilane (KBM-903, from Shin-Etsu Chemical Co., Ltd.)
Organosilicon compound (25): 3-Aminopropyltriethoxsilane (KBE-903, from Shin-Etsu Chemical Co., Ltd.)
Organosilicon compound (26): N-butyl-3-(trimethoxysilyl)propylamine (X-12-806, from Shin-Etsu Chemical Co., Ltd.)
Organosilicon compound (27): Bis[3-(trimethoxysilyl)propyl]amine (KBM-666P, from Shin-Etsu Chemical Co., Ltd.)

As shown in Tables 1 and 2, it is apparent that the adhesive compositions of the invention containing the organosilicon compounds of Examples 1-1 to 1-5 and 2-1 to 2-5 have excellent shelf stabilities when the organosilicon compounds are mixed with an isocyanate compound or an epoxy resin.

### [2] Urethane Prepolymer Synthesis

### Synthesis Example 6

Six hundred grams of polypropylene ether triol having a number-average molecular weight of 5,000 (G-5000; available under the trade name “EXCENOL 5030” from AGC Inc.) and 300 g of polypropylene ether diol having a number-average molecular weight of 2,000 (D-2000, available under the trade name “EXCENOL 2020” from AGC Inc.) were poured into a flask, heated at between 100 and 130° C. and stirred under deaeration, dehydrating the flask contents to a moisture level of 0.01% or less.

Next, the system was cooled to 90° C. and diphenylmethane diisocyanate (MDI, available under the trade name “Sumidur 44S” from Sumitomo Bayer Japan KK) was added in an amount such that the NCO/OH equivalent ratio (moles of NCO groups/moles of OH groups) becomes 1.70, following which the reaction was made to proceed for about 24 hours in a nitrogen atmosphere, thereby preparing a urethane prepolymer.

### [3] Preparation of Urethane Compositions and Production of Cured Products

### Examples 3-1 to 3-10, Comparative Examples 3-1 and 3-2

The urethane compositions were prepared by mixing the ingredients together in the usual manner in the proportions shown in Table 3 below.

### [Adhesiveness]

The prepared compositions were each coated onto a glass plate (50 mm×50 mm×5 mm thick) as the adherend, then dried under applied heat at 120° C. for 10 minutes, thereby fabricating composite materials consisting of an adhesive layer formed on an adherend.

In addition, under similar conditions, the prepared compositions were each coated onto, respectively, an anodized aluminum plate (50 mm×50 mm×3 mm thick), an acrylic resin plate (50 mm×50 mm×3 mm thick) and a polyester plate (50 mm×50 mm×3 mm thick), and these were dried, thereby fabricating composite materials consisting of an adhesive layer formed on an adherend.

The interfacial state between the adherend and the adhesive layer was visually examined by carrying out a hand peeling test in which each of the resulting composite materials is left to stand for 3 days at 23° C. and 55% RH and thereby cured, following which the adhesive layer is cut with a knife and the cut portion is peeled off by hand. The results are shown in Table 3.

TABLE 3

| | | | | | | | | | | | Comparative | |
|---|---|---|---|---|---|---|---|---|---|---|---|---|
| Ingredients | Example | | | | | | | | | | Example | |
| (pbw) | 3-1 | 3-2 | 3-3 | 3-4 | 3-5 | 3-6 | 3-7 | 3-8 | 3-9 | 3-10 | 3-1 | 3-2 |
| Urethane | 64 | 94 | 64 | 94 | 64 | 94 | 64 | 94 | 64 | 94 | 64 | 64 |
| prepolymer | | | | | | | | | | | | |
| Curing | 1 | 1 | 1 | 1 | 1 | 1 | 1 | 1 | 1 | 1 | 1 | 1 |
| catalyst | | | | | | | | | | | | |
| Organosilicon | 5 | 5 | — | — | — | — | — | — | — | — | — | — |
| compound (13) | | | | | | | | | | | | |
| Organosilicon | — | — | 5 | 5 | — | — | — | — | — | — | — | — |
| compound (14) | | | | | | | | | | | | |
| Organosilicon | — | — | — | — | 5 | 5 | — | — | — | — | — | — |
| compound (15) | | | | | | | | | | | | |
| Organosilicon | — | — | — | — | — | — | 5 | 5 | — | — | — | — |
| compound (20) | | | | | | | | | | | | |
| Organosilicon | — | — | — | — | — | — | — | — | 5 | 5 | — | — |
| compound (22) | | | | | | | | | | | | |
| Organosilicon | — | — | — | — | — | — | — | — | — | — | 5 | — |
| compound (28) | | | | | | | | | | | | |
| Organosilicon | — | — | — | — | — | — | — | — | — | — | — | 5 |
| compound (29) | | | | | | | | | | | | |
| Calcium | 30 | — | 30 | — | 30 | — | 30 | — | 30 | — | 30 | 30 |
| carbonate | | | | | | | | | | | | |
| Carbon black | — | 20 | — | 20 | — | 20 | — | 20 | — | 20 | — | — |

Adhesiveness evaluation results

| | | | | | | | | | | | | |
|---|---|---|---|---|---|---|---|---|---|---|---|---|
| Float glass | cohe- | cohe- | cohe- | cohe- | cohe- | cohe- | cohe- | cohe- | cohe- | cohe- | inter- | inter- |
| | sive | sive | sive | sive | sive | sive | sive | sive | sive | sive | facial | facial |
| | failure | failure | failure | failure | failure | failure | failure | failure | failure | failure | failure | failure |
| Anodized | cohe- | cohe- | cohe- | cohe- | cohe- | cohe- | cohe- | cohe- | cohe- | cohe- | inter- | inter- |
| aluminum | sive | sive | sive | sive | sive | sive | sive | sive | sive | sive | facial | facial |
| | failure | failure | failure | failure | failure | failure | failure | failure | failure | failure | failure | failure |
| Acrylic | cohe- | cohe- | cohe- | cohe- | cohe- | cohe- | cohe- | cohe- | cohe- | cohe- | inter- | inter- |
| resin | sive | sive | sive | sive | sive | sive | sive | sive | sive | sive | facial | facial |
| | failure | failure | failure | failure | failure | failure | failure | failure | failure | failure | failure | failure |
| Polyester | cohe- | cohe- | cohe- | cohe- | cohe- | cohe- | cohe- | cohe- | cohe- | cohe- | inter- | inter- |
| resin | sive | sive | sive | sive | sive | sive | sive | sive | sive | sive | facial | facial |
| | failure | failure | failure | failure | failure | failure | failure | failure | failure | failure | failure | failure |

Urethane prepolymer: Synthesis Example 6
Curing catalyst: Dibutyltin dilaurate
Organosilicon compound (28): 3-Triethoxysilyl-N-(1,3-dimethylbutylidene)propylamine (KBE-9103, from Shin-Etsu Chemical Co., Ltd.)
Organosilicon compound (29): 3-Isocyanatopropyltriethoxysilane (KBE-9007, from Shin-Etsu Chemical Co., Ltd.)

### [4] Preparation of Epoxy Compositions and Production of Cured Products

### Examples 4-1 to 4-5, Comparative Examples 4-1 to 4-3

The epoxy compositions were prepared by mixing the ingredients together in the usual manner in the proportions shown in Table 4 below.

The adhesiveness and shear strength of the resulting compositions were measured and evaluated as described below.

### [Adhesiveness]

The compositions were each coated onto a glass plate (50 mm×50 mm×5 mm thick) as the adherend and cured by being left to stand at 23° C. and 55% RH for 5 days, thereby fabricating a test piece. The adhesive properties of the resulting test pieces were evaluated by the following methods.

Crosscut Peel Test: Carried out in accordance with JIS K 5400
Adhesiveness after Water Resistance Test:
The test piece was immersed in water at room temperature for 24 hours, following which a crosscut peel test was carried out.
   Adhesiveness after Boiling Test:
The test piece was immersed in boiling water at 100° C. for 2 hours, following which a crosscut peel test was carried out.

The results are presented in Table 4. The evaluation results shown in Table 4 indicate the number of crosscut squares remaining after peeling (maximum=100).

### [Shear Strength]

Two stainless steel plates (width, 25 mm; from KDS K.K.) were overlapped 10 mm at the ends in such a way as to sandwich therebetween a 0.01 mm thickness of the resulting composition, and the composition was cured by leaving this assembly at rest for 5 days at room temperature, thereby fabricating a test piece made up of two stainless steel plates bonded by an epoxy resin composition (bonding surface area, 25 mm×10 mm=250 mm²)

The respective ends of this test piece were pulled in mutually opposing directions at a test rate of 50 mm/min using a tensile tester (Autograph, from Shimadzu Corporation), and the adhesive strength (MPa) per unit surface areas was determined. The results are presented in Table 4. The shear strengths (relative ratios) in Table 4 are the measured values obtained in each Example divided by the value obtained in Comparative Example 4-1.

TABLE 4

| | Example | | | | | Comparative Example | | |
|---|---|---|---|---|---|---|---|---|
| Ingredients (pbw) | 4-1 | 4-2 | 4-3 | 4-4 | 4-5 | 4-1 | 4-2 | 4-3 |
| Epoxy resin | 100 | 100 | 100 | 100 | 100 | 100 | 100 | 100 |
| Catalyst | 44 | 44 | 44 | 44 | 44 | 44 | 44 | 44 |
| Organosilicon compound (13) | 1 | — | — | — | — | — | — | — |
| Organosilicon compound (14) | — | 1 | — | — | — | — | — | — |
| Organosilicon compound (15) | — | — | 1 | — | — | — | — | — |
| Organosilicon compound (20) | — | — | — | 1 | — | — | — | — |
| Organosilicon compound (22) | — | — | — | — | 1 | — | — | — |
| Organosilicon compound (28) | — | — | — | — | — | — | 1 | — |
| Organosilicon compound (30) | — | — | — | — | — | — | — | 1 |

Evaluation results

| | | | | | | | | |
|---|---|---|---|---|---|---|---|---|
| Adhesive properties | 100 | 100 | 100 | 100 | 100 | 100 | 100 | 100 |
| Adhesiveness after water resistance test | 100 | 100 | 100 | 100 | 100 | 100 | 100 | 50 |
| Adhesiveness after boiling test | 100 | 100 | 100 | 100 | 100 | 0 | 100 | 100 |
| Shear strength (relative ratio) | 1.6 | 1.5 | 1.6 | 1.5 | 1.8 | 1.0 | 0.9 | 1.0 |

Epoxy resin: jER828 (Mitsubishi Chemical Corporation)
Catalyst: H3 (moisture-curable epoxy curing agent, from Mitsubishi Chemical Corporation)
Organosilicon compound (30): 3-Glycidoxypropyltrimethoxysilane (KBM-403, from Shin-Etsu Chemical Co., Ltd.)

As shown in Tables 3 and 4, it is apparent that the organosilicon compound-containing urethane adhesive compositions and epoxy adhesive compositions in Examples 3-1 to 3-10 and 4-1 to 4-5 all have a high adhesiveness.

1. An adhesive composition comprising an organosilicon compound of formula (1) below 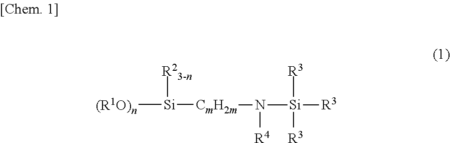
(wherein each R¹ is independently an alkyl group of 1 to 10 carbon atoms or an aryl group of 6 to 10 carbon atoms; each R² is independently an alkyl group of 1 to 10 carbon atoms or an aryl group of 6 to 10 carbon atoms; each R³ is independently a substituted or unsubstituted alkyl group of 1 to 20 carbon atoms, a substituted or unsubstituted aryl group of 6 to 10 carbon atoms, a substituted or unsubstituted aralkyl group of 7 to 10 carbon atoms, a substituted or unsubstituted alkenyl group of 2 to 10 carbon atoms or a substituted or unsubstituted alkoxy group of 1 to 20 carbon atoms, with the proviso that at least one R³ is a substituted or unsubstituted alkoxy group of 1 to 20 carbon atoms; R⁴ is an alkyl group of 1 to 10 carbon atoms, an aryl group of 6 to 10 carbon atoms, an aralkyl group of 7 to 10 carbon atoms or an organic group of formula (2) below 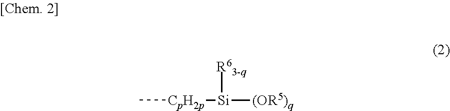
(each R⁵ being independently an alkyl group of 1 to 10 carbon atoms or an aryl group of 6 to 10 carbon atoms; each R⁶ being independently an alkyl group of 1 to 10 carbon atoms or an aryl group of 6 to 10 carbon atoms; p being an integer from 0 to 12; q being an integer from 1 to 3; and the dashed line representing a bond); n is an integer from 1 to 3; and m is an integer from 1 to 12).

2. The adhesive composition of claim 1, wherein the organosilicon compound includes at least one organosilicon compound of formulas (7) to (12) below 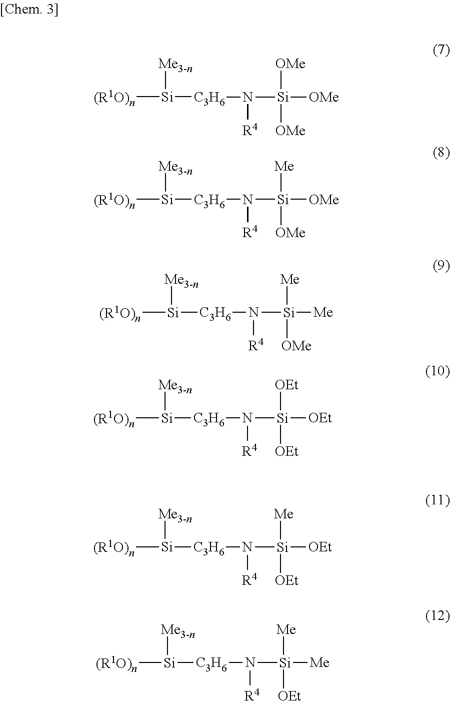
(wherein R¹, R⁴ and n are as defined above, Me represents a methyl group and Et represents an ethyl group).

3. The adhesive composition of claim 1, comprising from 0.01 to 10 parts by weight of the organosilicon compound of formula (1) per 100 parts by weight of a urethane prepolymer.

4. The adhesive composition of claim 1, comprising from 0.01 to 10 parts by weight of the organosilicon compound of formula (1) per 100 parts by weight of an epoxy compound.

5. The adhesive composition of claim 2, comprising from 0.01 to 10 parts by weight of the organosilicon compound of formula (1) per 100 parts by weight of a urethane prepolymer.

6. The adhesive composition of claim 2, comprising from 0.01 to 10 parts by weight of the organosilicon compound of formula (1) per 100 parts by weight of an epoxy compound.
